(19) United States
(12) Patent Application Publication
(10) Pub. No.: US 2010/0218164 A1
(43) Pub. Date: Aug. 26, 2010

(54) Pattern Quality Verification Model

(75) Inventors: Nien Lin Hsueh, Jhongli City (TW); Peng-Hua Chu, Jhongli City (TW); Jonathan Lee, Jhongli City (TW)

Correspondence Address: Jackson Intellectual Property Group PLLC, 106 Starvale Lane, Shipman, VA, 22971, US

(73) Assignee: National Central University, Taoyuan County (TW)

(21) Appl. No.: 12/192,666

(22) Filed: Aug. 15, 2008

Related U.S. Application Data
(60) Provisional application No. 61/064,669, filed on Mar. 19, 2008.

(51) Int. Cl. G06F 9/44

(52) U.S. Cl. 717/104

(57) ABSTRACT

Design pattern is redefined to focus on its quality focus. An approach, based on object-oriented quality model, is provides to validate if a design pattern answers whether a proposed structural model of the design pattern really resolves quality problems described in intent of the design pattern. A validation approach is proposed to check if the design pattern is well-designed. In addition, a quantitative method is proposed to measure an effectiveness of quality improvement of the design pattern for determining whether the design pattern is applicable to meet functional and quality requirements.

### FIELD OF THE INVENTION

The present invention relates to verifying design pattern; more particularly, relates to providing an approach to validate if a design pattern is well-designed and providing a quantitative method to measure an effectiveness of quality improvement of the design pattern.

### DESCRIPTION OF THE RELATED ARTS

In recent years, the influence of design patterns on software quality has attracted an increasing attention in the area of software engineering, as design patterns encapsulate valuable knowledge to resolve design problems, and more importantly to improve design quality. As the paradigm continues to increase in popularity, a systematic and objective approach to verify a design pattern is increasingly important.

In general, a design pattern consists of four essential sessions: pattern name, intent, solution, and consequences. The intent session indicates a problem the design pattern wants to resolve. The solution session describes a structural model for the problem. The solution is informally presented by using class and interaction diagrams in model level. For instance, a solution structure of a design pattern “Abstract Factory” is presented in FIG. 4A, showing an example of two products families (family A and family B). The limitation of this concept is, though Abstract Factory can be applied to multiple product families, the structure cannot convey this concept in a systematic way.

A role-based model proposed by France et al. formally specifies pattern solution in a meta-model level. A role in the meta-model representation specifies the properties a model element must have if it is to be part of the pattern solution model. Referring to the Abstract Factory example, as shown in FIG. 4B, roles defined in this pattern include AbstractFactory, ConcreteFactory, AbstractProduct, ConcreteProduct and Client. FIG. 4B represents a structural solution based on the role-based approach. Please note that the model elements ProductA and ProductB groups in FIG. 4A are now modeled as a role ConcreteProduct.

In order to provide a quantitative approach to relate measurable object-oriented characteristics to the higher-level desirable software quality attributes, a generic quality model proposed by Dromey is extended by Bansiya and Davis to propose a hierarchical model for an object-oriented design quality assessment approach, called “Quality Measurement of Object Oriented Design” (QMOOD). As shown in FIG. 5A, there are four levels and three mappings between these levels in QMOOD. While defining the levels involves identifying design qua attributes, object-oriented design properties, object-oriented design metrics, and object-oriented design components, defining the mapping involves connecting adjacent levels by linking a lower level to the next higher level. Reusability, flexibility, effectiveness, understandability, functionality, and extendibility are selected as a typical set of quality attributes in the QMOOD level one.

Design properties defined in level two are used to assess the quality attributes in level one. For example, as shown in FIG. 5B, coupling is used to assess reusability. The linkage I₁₂ indicates that a model with lower coupling possesses the attribute of high reusability. To measure the coupling degree, a metric coupling factor (COF) is defined in level three for counting different numbers of classes that a class is directly related to. The linkage I₂₃ indicates that COF is related to the coupling property. Level four elements consist of a set of primitive elements in an object model, including objects, classes, relationships, generalization, etc. The linkage I₃₄ indicates that class and relationship in level four are elements that are related to the COF metric.

Design patterns usually provide a possible way to deal with non-functional requirements since they provide solutions to satisfy functional requirements as well as “better” solutions to meet non-functional requirements. However, the prior arts do not clearly show changes in structure and improvement in quality after applying a design pattern. Hence, the prior arts do not fulfill all users' requests on actual use.

### SUMMARY OF THE INVENTION

The main purpose of the present invention is to provide an approach based on object-oriented quality model to validate if a design pattern is well-designed and to provide a quantitative method to measure an effectiveness of quality improvement of the design pattern for determining whether the design pattern is applicable to meet functional and quality requirements.

To achieve the above purpose, the present invention is a design pattern quality verification model, comprising a functional requirement intent (I_{F}) describing functional requirement of a design pattern (dp); a nonfunctional requirement intent (I_{N}) describing nonfunctional requirement of the dp; a quality focus (Q) representing a qua focus from the I_{F} to the I_{N}; a functional-requirement structure (S_{F}) representing a structure realizing the I_{F}; a nonfunctional-requirement structure (S_{N}) representing a structure realizing the I_{N}; and a transformation (T) representing a transformation function from the S_{F} to S_{N}, wherein, the dp is thus defined as <I_{F},IN,Q,SF,SN,T>. Accordingly, a novel design pattern quality verification model is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the view showing the preferred embodiment according to the present invention;

FIG. 2 is the view showing the model transformation;

FIG. 3 is the view showing the relationship between elements of the design pattern;

FIG. 4A is the classical view of the prior art;

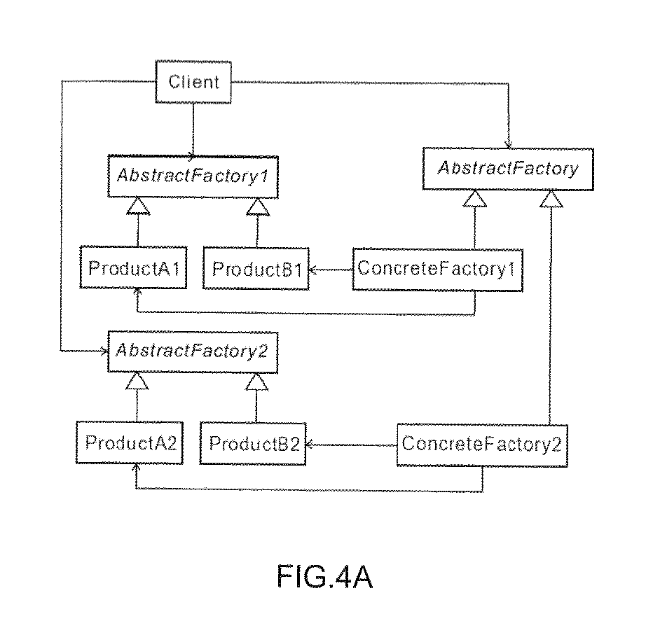

FIG. 4B is the role-based view of the prior art;

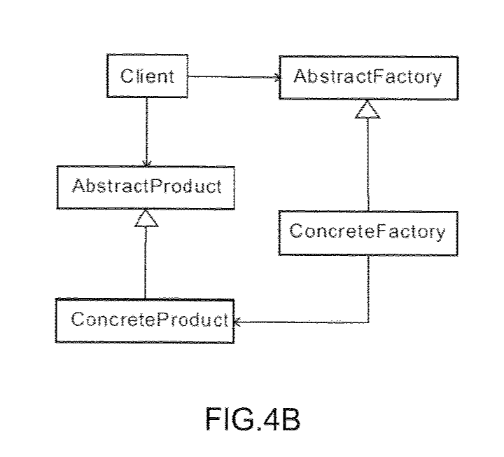

FIG. 5A is the view of the QMOOD model; and

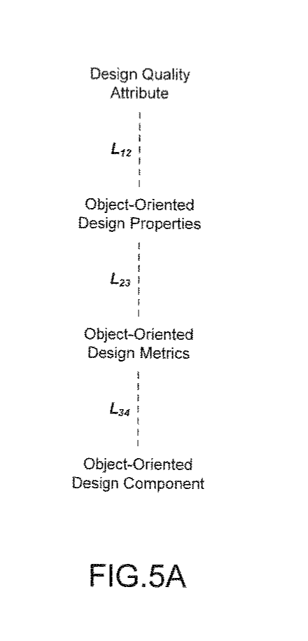

FIG. 5B is the view of the QMOOD example.

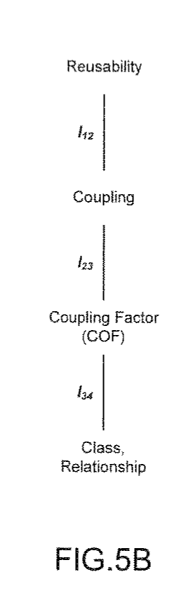

### DESCRIPTION OF THE PREFERRED EMBODIMENT

The following description of the preferred embodiment is provided to understand the features and the structures of the present invention.

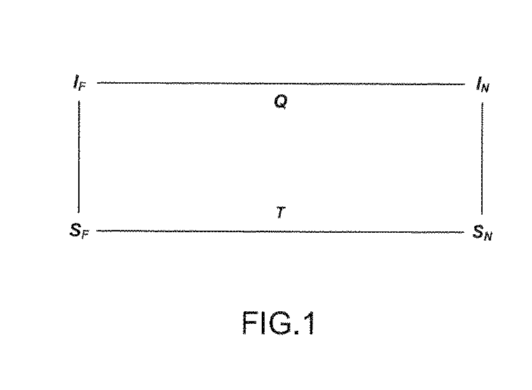

Please refer to FIG. 1 to FIG. 3, which are a view showing a preferred embodiment according to the present invention; a view showing the model transformation and a view showing a relationship between elements of a design pattern. As shown in the figures, the present invention is a design pattern quality verification model, where a design pattern is redefined as <I_{F},I_{N},Q,S_{F},S_{N},T>; I_{F} is a functional requirement intent (FR-intent), describing what does the pattern do; I_{N} is a nonfunctional requirement intent (NFR-intent), describing how well is the pattern contributes to quality attributes, such as reusability, maintenance or extensibility; Q is a quality focus, representing a quality focus from I_{F} to I_{N}; S_{F} is a functional-requirement structure (FR-structure), representing a structure that realizes the functional requirement intent (I_{F}); S_{N} is a nonfunctional-requirement structure (NFR-structure), representing a structural that enhances the non-functional requirement intent (I_{N}); and T is a transformation, representing a transformation function from S_{F} to S_{N}. Thus, through the present invention, an approach based on object-oriented quality model is provided to validate if a design pattern is well-designed; and a quantitative method is proposed to measure an effectiveness of quality improvement of the design pattern for determining whether the design pattern is applicable to meet functional and quality requirements.

Both the FR-intent and the NFR-intent are text descriptions to specify the functional and non-functional intent of a design pattern. The FR-structure and the NFR-structure specify structures for fulfilling the FR-intent and the NFR-intent, respectively. The NFR-structure can enhance the NFR-intent in the sense that it can satisfy the NFR-intent to a higher degree than compared to its associated FR-structure. Note that the FR-structure and the NFR-structure are meta-models and represented by role-based approach. The FR-structure and the NFR-structure are denoted as S_{F} and S_{N}, respectively.

The transformation T represents the essence of a design pattern. The transformation T maps a FR-structure to a NFR-structure. That is, s S_{F}(dp) and T(s) S_{N}(dp) where the notation denotes an instantiation relationship between model and meta-model and s S means that a model s is an instance model of a meta-model S of a design pattern dp.

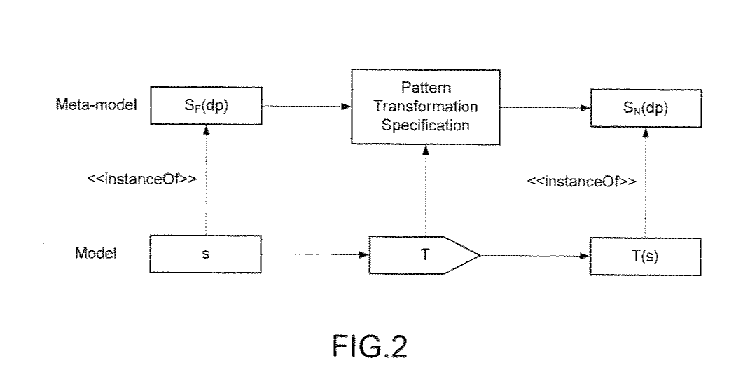

As shown in FIG. 2, a transformation is illustrated. First, the S_{F} and S_{N} of dp is designed at the metamodel level, and randomly generate s by S_{F}(dp). In order to execute such a transformation, Pattern Transformation Specification is designed at the metamodel level, so that T can transform s into T(s), which corresponds to S_{N}(dp) and automatically validate the correctness of the model.

For simplicity, QMOOD model is referred to as φ. A set of quality elements in the QMOOD level i is denoted as φᵢ, and the set of link ij is denoted as φᵢⱼ. If an element (x,y) φ₂₃ then y is an object-oriented design metric defined in φ₃, used to evaluate the object-oriented property x defined in φ₂. To more explicitly highlight the quality issue that a design pattern addresses, the extension from the FR-intent to the NFR-intent is defined as a quality focus Q(I_{F},I_{N})=<property,constraint>. The property refers to an object-oriented design property defined in φ₂, which may design size, hierarchy, abstraction, encapsulation, coupling, cohesion, composition, inheritance, polymorphism, message, or complexity. The constraint refers to the expected constraint on the subject's property, which may be increased, decreased or maintained. The constraint increased means that the NFR-intent expects to maximize the design property. A design pattern's quality focus Q is also denoted as Q_{dp}(I_{F},I_{N}) to explicitly indicate that the quality focus is derived from I_{F} to I_{N}.

Considering an original intent described in an “Observer” design pattern: Define an one-to-many dependency between objects so that when one object changes state, all its dependents are automatically notified and updated. The Observer design pattern is designed to address a communication problem between subject objects and related observer objects. Viewing from a functional aspect, it requires the subject to notify all observers when it changes its state. Viewing from a non-functional aspect, it requires the notification to work automatically without knowing the types of observers. A quality focus of the Observer design pattern is formulated as <coupling,decreased>, meaning that it intends to decrease the coupling. Note that the property of coupling is not only a general notion in the object orientation, but also object oriented properties defined in level 2 of QMOOD (i.e. φ₂).

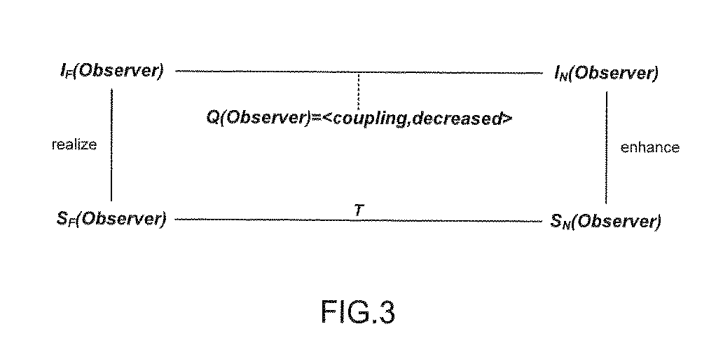

As shown in FIG. 3, the FR-structure is a meta-model to realize the FR-intent, whereas the NFR-structure is a meta-model to enhance the NFR-intent. The quality form is defined on the extension between the FR-intent and the NFR-intent to explicitly indicate the qualify focus. The transformation is defined between the FR-structure and NFR-structure to indicate the mapping of their instance models.

Let μ be an object oriented metric and μ(m) denotes metric value of an object model m. (p,μ) φ₂₃ as μ is used to evaluate an object oriented design property P (since φ₂₃ defines a link between property and metric). μ(m₁)<μ(m₂) means that model m₂ possesses a higher property P than m₁. Given the model m, μ(m) is calculated directly based on the definition of the metric μ. For example, COF (COupling Factor) a metric to assess property coupling, which is defined as:

$$\frac{{\sum }_{i = 1}^{TC} \vert {\sum }_{j = 1}^{TC} is\_client ( {C}_{i} , {C}_{j} ) \vert}{{TC}^{2} - TC} ,$$

where TC is a total number of classes and

$$is\_ckient ( {C}_{i} , {C}_{j} ) = \begin{matrix}1 & iif Ci \ddot{E} Cj ¿ Ci , Cjq \\ 0 & otherwise .\end{matrix}$$

The is_client function returns 1 if class Cᵢ contains at least one non-inheritance reference to class Cⱼ, where a reference is an argument type, a returned value, or a call to methods of server classes.

A notion of object metric is applied in meta-level to evaluate the transformation. μ(M,T) is a metric to evaluate the effectiveness of a transformation on a meta model:

$$μ ( M , T ) = {G}_{m ∈ \overline{M}} ( \frac{μ ( T ( m ) ) - μ ( m )}{μ ( m )} ) ,$$

where G is an aggregation function such as an average function. M̅ is a typical model set whose elements are instantiated from M and represent a typical case in a context. μ(M,T)>0 means that the transformation T enhances the property P; that is, T can transform instances of M into another model with a higher P. The transformation T is effectiveless on the meta model M with respect to the property P if μ(M,T)=0. The transformation T impairs the property P if μ(M,T)<0. Based on μ(M,T), a quality improvement effectiveness on property P of a design pattern dp (denoted as QIE_{P}(dp)) is defined. Assume a design pattern dp=<I_{F},I_{N},<P,C>,S_{F},S_{N},T>, its QIE_{P} is measured on basis of the FR-structure S_{F}, the transformation T, and the metric μ:

$${QIE}_{p} ( dp ) = μ ( {S}_{F} , T ) = {G}_{s ∈ \overline{{S}_{F}}} ( {QIE}_{{S}_{F} , {S}_{N}} ) = {G}_{s ∈ \overline{{S}_{F}}} ( \frac{μ ( T ( s ) ) - μ ( s )}{μ ( s )} ) .$$

QIE_{S}_{_{F}}_{,S}_{_{N}} is the quality improvement effectiveness measurement from FR-structure to NFR-structure. QIE_{P}(dp)>0 means that applying the design pattern dp will enhance the property P, whereas QIE_{P}(dp)<0 means that dp impairs the property P. Furthermore, the value |QIE_{P}(dp)| is larger, the dp impacts the property P more. If QIE_{P}(dp)=0, the design pattern is inefficacious to P.

A design pattern is defined as a quality improver if its quality intent is consistent with its structure. To validate consistency, the QIE_{P} is checked with the constraint defined in the quality focus. A design pattern dp=<I_{F},I_{N},<P,C>,S_{F},S_{N},T> is a property P improver if

$${QIE}_{P} ( dp ) = \{ \begin{matrix}> 0 & if C {=}^{``} {increased}^{″} \\ > 0 & if C {=}^{``} {decreased}^{″} \\ = 0 & if C {=}^{``} {maintained}^{″} .\end{matrix}$$

P-improver(dp) is used to denote dp is a design pattern improver on property P. When a design pattern dp is a quality improver, it implies its NFR-structure provides a better solution for enhancing the NFR-intent; that is,

P-improver(dp) [symbol] d(I_{N},S_{F})<d(I_{N},S_{N}),

where d(intent,structure) is a satisfaction function, representing a degree to which the intent is realized in the structure. The degree is called satisfaction degree in the present invention. If the intent is a functional intent, the degree is either 1 (satisfied) or 0 (not satisfied). If the intent is non-functional, the degree ranges between 0 and 1. The satisfaction degree is just a concept, not directly measured. The predicate d(I_{N},S_{F})<d(I_{N},S_{N}) is indirectly derived by evaluating whether or not the design pattern is a P-improver. If the design pattern is a P-improver, d(I_{N},S_{F})<d(I_{N},S_{N}) is true, which means the NFR-intent is satisfied to a greater degree in the non-functional than in the functional structure.

When the NFR-structure is applied to enhance the satisfaction degree of the NFR-intent, it has to make sure the NFR-structure does not impair the original FR-intent of the pattern. A well-designed P-improver is thus defined as follows:
A design pattern dp is a well-designed P-improver if it is a P-improver and its NFR-structure does not impair its FR-intent; that is,

P*-improver(dp) [symbol] P-improver(dp) [symbol] (d(I_{F},S_{N})=satisfied)

d(I_{F},S_{N})=satisfied means the FR-intent is not impaired by the NFR-structure. Judgment of the condition is made by examining if the classes in S_{N} have enough operations and proper interactions to implement the functionality of I_{F}.

The present invention provides an approach, based on object-oriented quality model, to validate if a design pattern is well-designed; that is, it answers whether a proposed structural model of the design pattern really resolves quality problems described in intent of the design pattern. A validation approach is proposed to check if the design pattern is well-designed. In addition, a quantitative method is proposed to measure an effectiveness of quality improvement of the design pattern for determining whether the design pattern is applicable to meet functional and quality requirements.

To sum up, the present invention is a design pattern quality verification model, where an approach based on object-oriented quality model is provided to validate if a design pattern is well-designed; and a quantitative method is proposed to measure an effectiveness of quality improvement of the design pattern for determining whether the design pattern is applicable to meet functional and quality requirements.

The preferred embodiment herein disclosed is not intended to unnecessarily limit the scope of the invention, Therefore, simple modifications or variations belonging to the equivalent of the scope of the claims and the instructions disclosed herein for a patent are all within the scope of the present invention.

What is claimed is:

1. A design pattern quality verification model, comprising:
a functional requirement intent (I_{F}) said I_{F} describing functional requirement of a design pattern (dp);
a nonfunctional requirement intent (I_{N}), said I_{N} describing nonfunctional requirement of said dp;
a quality focus (Q), said representing a quality focus from said I_{F} to said I_{N};
a functional-requirement structure (S_{F}), said S_{F} representing a structure realizing said I_{F};
a nonfunctional-requirement structure (S_{N}), said S_{N} representing a structure realizing said I_{N}; and
a transformation (T), said representing a transformation function from said S_{F} to S_{N},
wherein, said dp is thus defined as <I_{F},I_{N},Q,S_{F},S_{N},T>.

2. The model according to claim 1,
wherein said Q of said dp is defined as Q(I_{F},I_{N})=<property,constraint>;
wherein said property is an object-oriented design property; and
wherein said constraint is an expected constraint on said property.

3. The model according to claim 2,
wherein μ is an object-oriented metric and μ(M,T) is a metric to evaluate an effectiveness of said T on a meta model M;
wherein μ(M,T)>0 indicates said T enhances said property;
wherein μ(M,T)=0 indicates said T is effectiveless on said M with respect to said property P;
wherein μ(M,T)=0 indicates said T impairs said property P; and
wherein said M is a S_{F} of said dp.
